(19) United States
(12) Patent Application Publication
(10) Pub. No.: US 2012/0235512 A1
(43) Pub. Date: Sep. 20, 2012

(54) TRANSFER SWITCH MONITORING DEVICE AND METHOD

(75) Inventors: Robert Siciliano, Boonton, NJ (US); Daniel Scheffer, Boonton, NJ (US); John Hayes, Hardwick, NJ (US); John Petro, Florham Park, NJ (US)

(73) Assignee: ASCO POWER TECHNOLOGIES, L.P., Florham Park, NJ (US)

(21) Appl. No.: 13/051,683

(22) Filed: Mar. 18, 2011

(51) Int. Cl. H02B 1/24

(52) U.S. Cl. 307/112

(57) ABSTRACT

A method is provided and may include monitoring a transfer switch and determining an operating condition of the transfer switch based on the monitoring. The method may further include comparing by a processor the operating condition to a predetermined value, and determining a maintenance condition of the transfer switch based on the comparison.

### FIELD

The present disclosure relates to monitoring devices and more particularly to a monitoring device for a transfer switch.

### BACKGROUND

This section provides background information related to the present disclosure which is not necessarily prior art.

Various applications require a nearly constant supply of reliable electrical power to operate effectively. For example, hospitals require a constant and reliable supply of electricity to ensure medical equipment in operating rooms and the like function when needed. Further, food retailers such as supermarkets and grocery stores require a constant and reliable supply of electricity to properly operate refrigeration systems associated with display cases and freezers to prevent food spoilage.

While utility companies generally provide electrical power consistently and reliably, such power is sometimes interrupted due to inclement weather, unforeseen accidents, or maintenance. Interruptions in power, while irritating and unpleasant, are often tolerable by the general public. Institutions such as hospitals and businesses such as food retailers, on the other hand, cannot afford even minor interruptions in their power supply.

Consequently, electrical power consumers that cannot withstand even minor interruptions in their power supply often rely on generators and other backup systems to supply electrical power during periods when electrical service from a utility company is interrupted. Transfer switches enable these consumers to switch between a primary electrical source (i.e., from a utility company) and a secondary electrical source (i.e., a generator or other backup system) when one source becomes unreliable or requires maintenance.

### SUMMARY

This section provides a general summary of the disclosure, and is not a comprehensive disclosure of its full scope or all of its features.

A method is provided and may include monitoring a transfer switch and determining an operating condition of the transfer switch based on the monitoring. The method may further include comparing by a processor the operating condition to a predetermined value, and determining a maintenance condition of the transfer switch based on the comparison.

In another configuration, a controller for monitoring operation of a transfer switch is provided and may include a processor that receives at least one operating condition of the transfer switch and compares the at least one operating condition to at least one predetermined value. The processor may determine a maintenance condition of the transfer switch based on the comparison.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic representation of a transfer switch device;

FIG. 2 is a schematic representation of a controller in accordance with the principles of the present disclosure for use in monitoring a transfer switch;

FIG. 3 is a schematic representation of a timer module of the controller of FIG. 2;

FIG. 4 is a schematic representation of a temperature module of the controller of FIG. 2;

FIG. 5 is a schematic representation of a counter module of the controller of FIG. 2;

FIG. 6 is a schematic representation of a continuity module of the controller of FIG. 2;

FIG. 7 is a flowchart detailing operation of a method of monitoring a transfer switch in accordance with the principles of the present disclosure;

FIG. 8 is a flowchart detailing operation of a transfer timer test in accordance with the principles of the present disclosure;

FIG. 9 is a flowchart detailing operation of a transfer electrical wear test in accordance with the principles of the present disclosure;

FIG. 10 is a flowchart detailing operation of an operations count test in accordance with the principles of the present disclosure; and

FIG. 11 is a flowchart detailing operation of a continuity test in accordance with the principles of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

When an element or layer is referred to as being “on,” “engaged to,” “connected to” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors or a group of execution engines. For example, multiple cores and/or multiple threads of a processor may be considered to be execution engines. In various implementations, execution engines may be grouped across a processor, across multiple processors, and across processors in multiple locations, such as multiple servers in a parallel processing arrangement. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Various applications require a nearly constant supply of reliable electrical power to operate effectively. Unfortunately, the electrical power supplied by local utility companies cannot provide this reliability. Consequently, electrical power consumers have installed generators and other emergency systems to supply their needs for constant reliable electrical power. Transfer switches enable these consumers to switch between their primary electrical source and their secondary electrical source when one source becomes unreliable or requires maintenance.

With reference to the figures, a transfer switch 10 is provided and may include a housing 12, a controller 14 disposed within the housing 12, and a switch 16. The switch 16 may be connected to a primary electrical power source 18, a secondary electrical power source 20, and a load 22 to selectively couple the primary electrical power source 18 and the secondary electrical power source 20 to the load 22. While the primary electrical power source 18 is shown as a three-phase, four-pole source, the secondary electrical power source 20 is shown as a three-phase, four-pole source and the load 22 is shown as a three-phase load, the primary electrical power source 18, the secondary electrical power source 20, and the load 22 are not limited as such.

The switch 16 may include a series of contacts 26-32 for connecting each phase primary power source 18 to the switch 16, a series of contacts 34-40 for connecting each phase of the secondary power source 20 to the switch 16, and a series of contacts 42-48 for connecting each phase of the load 22 to the switch 16. The switch 16 may also include a series of switch mechanisms 50, 52, 54, 56 in respective electrical communication with the contacts 26-32 and a series of switch mechanisms 51, 53, 55, 57 in respective electrical communication with the contacts 34-40. The switch mechanisms 50, 52, 54, 56 may act in concert with respective switch mechanisms 51, 53, 55, 57 and/or with one another. Additionally, when selective supplying power to the load 22 from the power sources 18 and 20, switch mechanisms 50, 52, 54, 56 may be in the opposite state (i.e. either open or closed) as switch mechanisms 51, 53, 55, and 57. In some configurations, switch mechanism pairs 50 and 51, 52 and 53, 54 and 55, and 56 and 57 may operate as a double throw switches, double throw switches with an off delay, and/or double throw switches with a timed overlap.

Within the switch 16, the contacts 26-32 are in electrical communication with a respective primary power side (PS) of each switch mechanism 50, 52, 54, 56, the contacts 34-40 are in electrical communication with a respective secondary power side (PS) of each switch mechanism 51, 53, 55, 57, and the contacts 42-48 are in electrical communication with a respective load side (LS) of each switch mechanism 50-57. In this arrangement, for example, the primary power supply phase (A) is connected to contact 26, which is in electrical communication with the primary power side (PS) of switch mechanism 50, the secondary power phase (A) is connected to contact 34, which is in electrical communication with the secondary power side (PS) of switch mechanism 51, and the load phase (A) is connected to contact 42, which is in electrical communication with the load side (LS) of switch mechanism 50 and the load side (LS) of switch mechanism 51. The state of switch mechanisms 50 and 51 may change (i.e. either open and/or close) in order to selectively supply the phase (A) load 22 power from either the phase (A) primary or secondary power sources 18, 20. Each of phases (B) and (C) as well as neutral (N) are connected in a similar fashion and are therefore not described in detail.

When fully connected, the switch 16 selectively supplies the load 22 with power from either the primary electrical power source 18 or the secondary electrical source 20 depending on the state of the switch mechanisms 50-57. While eight (8) switch mechanisms 50-57 and twelve (12) contacts 26-48 are described and illustrated, the number of switch mechanisms 50-57 and contacts 26-48 may vary depending on the number of phases required by the load 22 and/or supplied by the primary and secondary power sources 18 and 20.

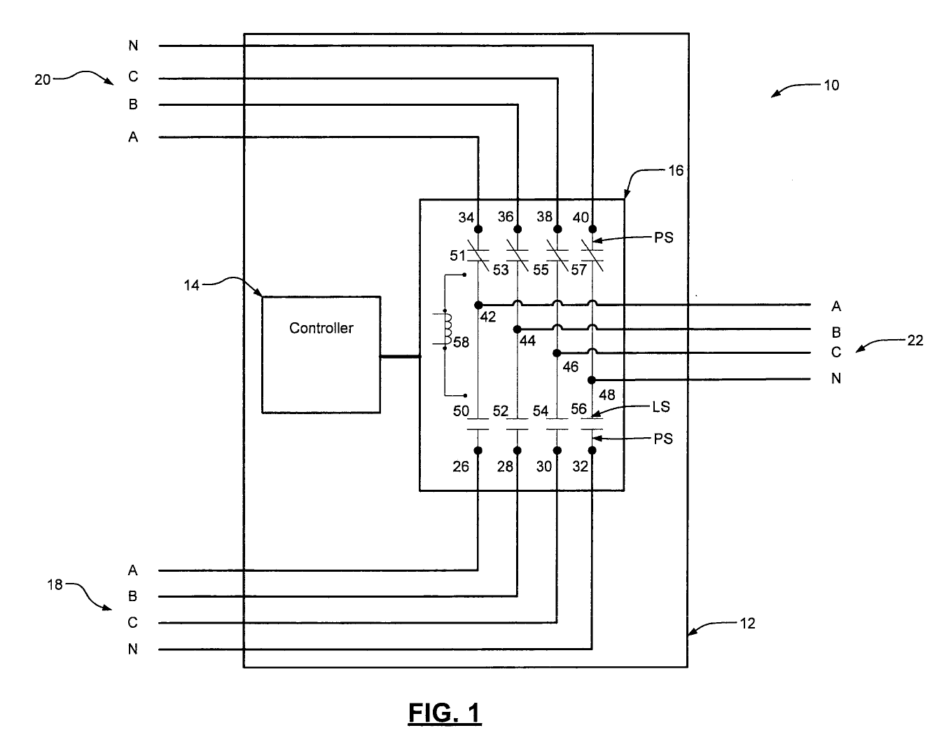

The switch 16 may also include at least one solenoid 58. The solenoid 58 may receive a signal from the controller 14 to move at least one of the switches 50-57 from a first or open state (shown in FIG. 1 with respect to switch mechanisms 50, 52, 54, 56) to a second or closed state (Shown in FIG. 1 with respect to switch mechanisms 51, 53, 55, 57). While the switch 16 is shown as including one solenoid 58, the switch 16 could include any number of solenoids 58 having various configurations depending on the particular switch 16 and the number of phases connected thereto.

The first and second states do not correspond to the position the switch mechanisms 50-57 relative to the power sources 18, 20. Rather, the first state corresponds to the position of the switch mechanisms 50-57 at the beginning of a transfer from one state to another and the second state corresponds to the position of the switch at the end of the transfer. Thus, the controller 14 may send a signal to energize the solenoid 58 which, in turn, moves at least one of the switch mechanisms 50-57 from the first state to the second state and effectively transfers the power supplied to the load 22 from one power source 18, 20 to the other power source 18, 20. For example, the controller 14 may cause the switch mechanisms 50, 52, 54, 56 to move from the closed state to the open state via the solenoid 58 and may cause the switch mechanisms 51, 53, 55, 57 to move from the open state to the closed state via the solenoid 58 to supply power from the secondary power source 20 to the load 22. The foregoing example is illustrated in FIG. 1, which shows the switch mechanisms 51, 53, 55, 57 in the closed state and supplying power from the secondary power source 20 to the load 22.

With continued reference to FIG. 1, the controller 14 may be disposed within the housing 12 and is in communication with the switch 16. The controller 14 may employ various forms of communication including, but not limited to, wired, wireless, optical, and infrared communication and may monitor the primary power source 18, the secondary power source 20, and the load 22. The controller 14 may further supervise and control the switch 16 and may control switching between the power sources 18, 20 and/or may provide information to a user interface—such as a display—to communicate information regarding the performance of the switch 16. While FIG. 1 shows a single controller 14 disposed within the housing 12 and in communication with the switch 16, the controller 14 could alternatively be located remotely from the housing 12.

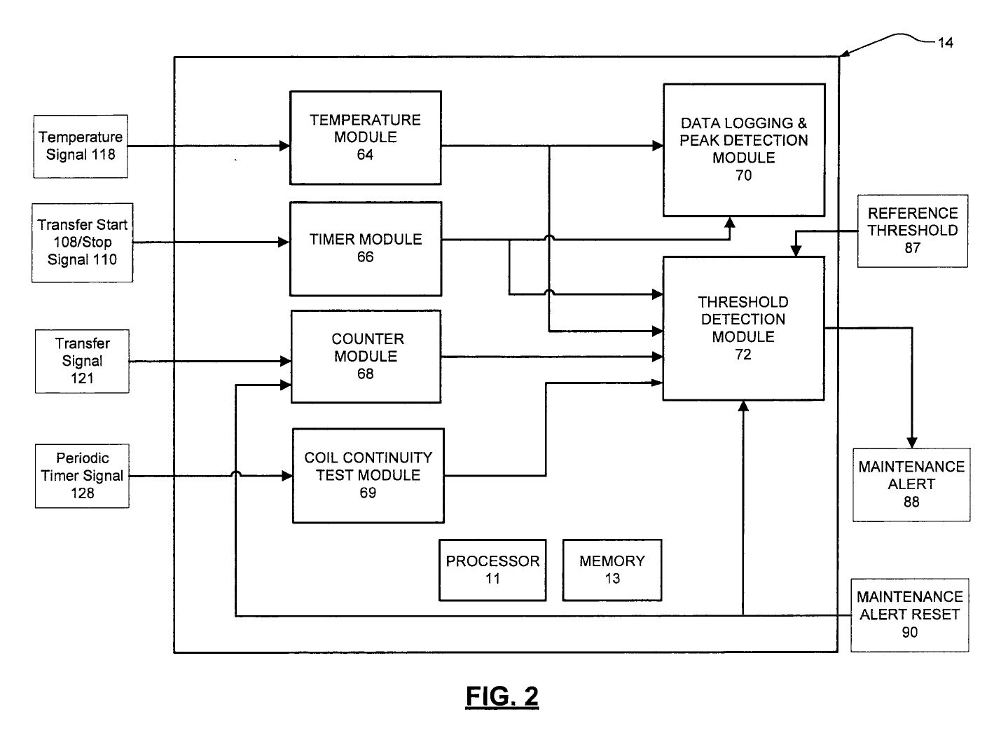

With particular reference to FIGS. 2-6, the controller 14 may include a processor 11 and memory 13 as well as various modules for monitoring operation of the transfer switch 10. For example, the controller 14 may include a temperature module 64, a timer module 66, a counter module 68, and a coil continuity test module 69. The modules 64, 66, 68, 69 may be executed by the processor 11 to allow the controller 14 to monitor performance and operation of the transfer switch 10.

The controller 14 may additionally include a data logging and peak detection module 70 and a threshold detection module 72 that may be used in conjunction with the various modules 64, 66, 68, 69. While the controller 14 is shown as including a temperature module 64, a timer module 66, a counter module 68, and a coil continuity test module 69 as well as a data logging and peak detection module 70 and a threshold detection module 72, the controller 14 could include any combination of modules 64, 66, 68, 69, 70, 72.

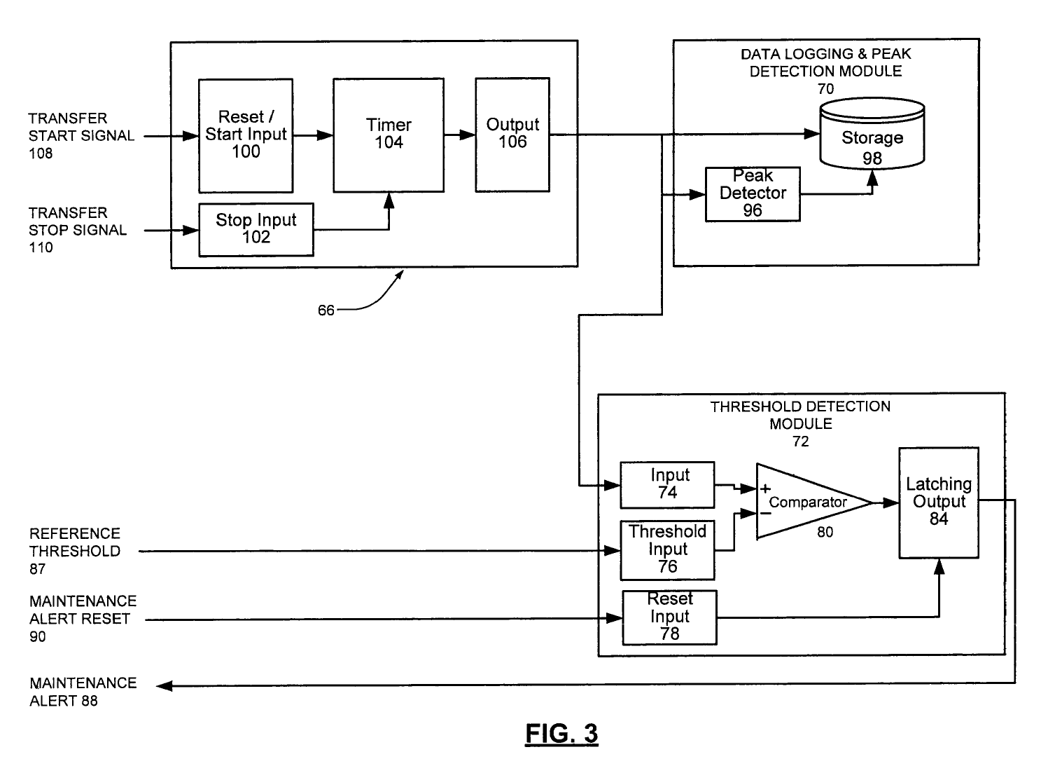

With particular reference to FIG. 3, the timer module 66 is shown in conjunction with the data logging and peak detection module 70 and threshold detection module 72. The timer module 66 may monitor operating conditions of the transfer switch 10 including the time required to move at least one of the switches 50-57 between the first state and the second state. As such, the timer module 66 may include a timer module 66 that includes a reset/start input 100, a stop input 102, a timing mechanism 104, and/or an output 106 in communication with one another.

The timer module 66 may monitor the transfer switch 10 for a transfer start signal 108 received at input 100 and/or a transfer stop signal 110 received at input 102. The transfer start signal 108 may include information that at least one of the switches 50-57 is moving from the first state and is communicated to the timer module 66 virtually simultaneously with initiation of movement of the switch 16. The transfer stop signal 110 may include information that at least one of the switches 50-57 is stationary, thereby completing movement from the first state to the second state. Such information may be communicated to the timer module 66 virtually simultaneously with termination of movement of the particular switch 50-57.

If a transfer stop signal 110 is not communicated to the timer module 66, the timer module 66 may alert the threshold detection module 72 that the particular switch 50-57 did not compete movement from one state to the other. For example, the timer module 66 may alert the threshold detection module 72 that the switch 16 is stuck between the first state and the second state. Such information may result in the threshold detection module 72 communicating a maintenance alert 88 specifying that the transfer switch 10 did not complete its movement between the first state and the second state. The transfer start signal 108 and the transfer stop signal 110 may include additional information identifying the particular switches 50-57 from which the signals are communicated to aid the controller 14 in diagnosing the transfer switch 10.

In this arrangement, a transfer start signal 108 may be communicated to the reset/start input 100 of the timer module 66. The input 100 may receive the transfer start signal 108, may reset the timing mechanism 104, and may initiate the timing mechanism 104. Initiation of the timing mechanism 104 allows the mechanism 104 to begin timing movement of at least one of the switches 50-57 from the first state to the second state. The transfer stop signal 110 is communicated to the input 102 of the timer module 66 upon completion of movement from the first state to the second state. The stop input 102 receives the transfer stop signal 110 and stops the timing mechanism 104.

The timing mechanism 104 may communicate timing information—which may include the time for at least one of the switches 50-57 to move from one of the first state and the second state to the other of the first state and the second state—to the output 106 of the timer module 66. The output 106 may communicate the timing information to module 70 and/or to the threshold detection module 72.

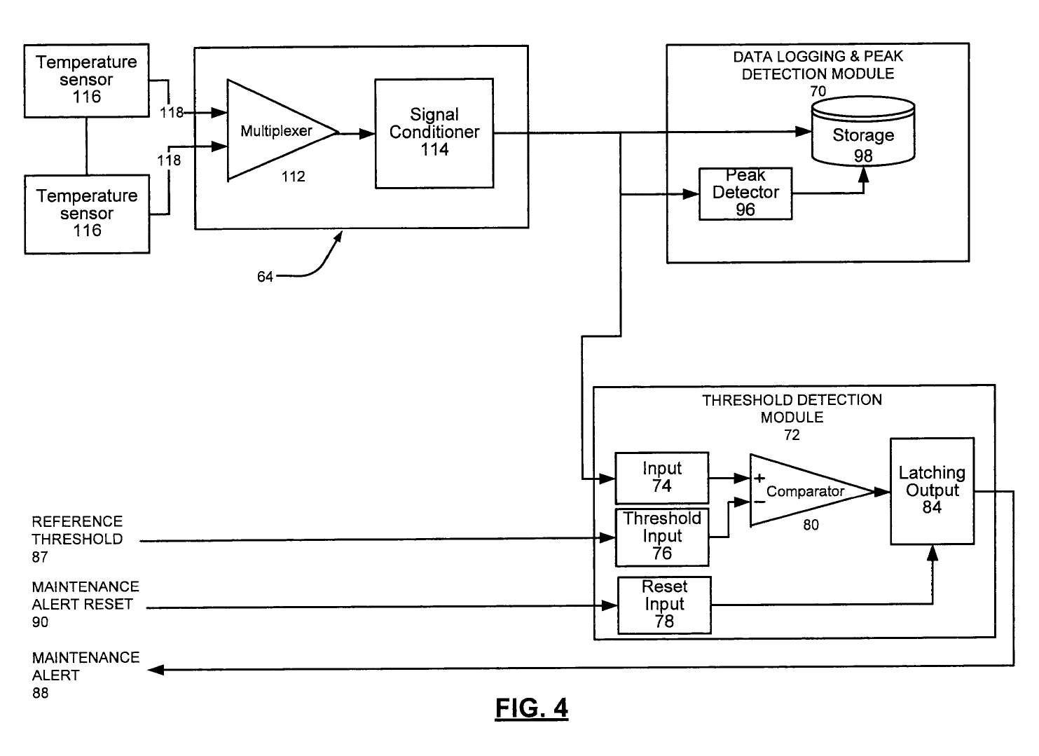

With particular reference to FIG. 4, the temperature module 64 is shown in conjunction with the data logging and peak detection module 70 and threshold detection module 72. The temperature module 64 monitors operating conditions of the transfer switch 10 including the temperature of at least one of the contacts 26-48. The temperature of at least one of the contacts 26-48 may be indicative of the electrical wear of the transfer switch 10 and may be useful when determining whether to issue a maintenance alert 88.

The temperature module 64 may be in communication with at least one temperature sensor 116 that measures the temperature of at least one contact 26-48. While FIG. 4 illustrates two temperature sensors 116, the controller 14 may include any number of temperature sensors 116 including less than or greater than two temperature sensors 116. The temperature sensor 116 may communicate a temperature signal 118 to the temperature module 64 including information about the temperature of at least one contact 26-48. The temperature module 64 may include a multiplexer 112 and/or a signal conditioner 114, whereby the temperature signals 118 are communicated by the temperature sensor 116 to the multiplexer 112. The multiplexer 112 selects a temperature signal 118 and communicates the signal to the signal conditioner 114. The signal conditioner 114 may condition the signal 118 and communicate temperature information to module 70 and/or to the threshold detection module 72 for further processing. The temperature information may include information about the temperature of at least one of the contacts 26-48.

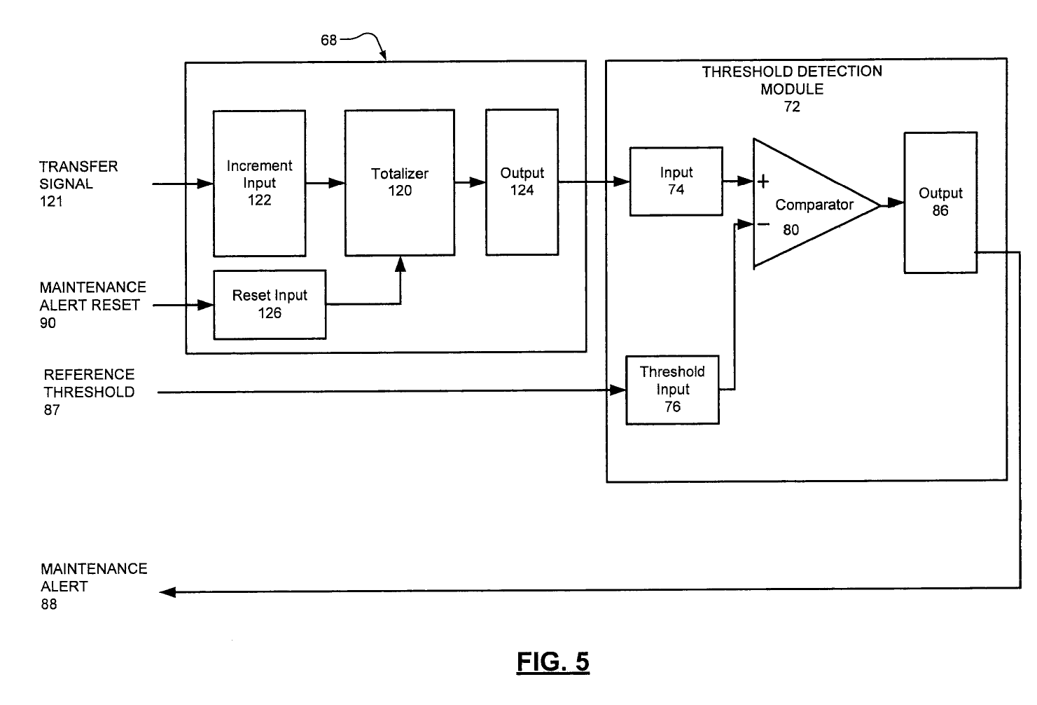

With particular reference to FIG. 5, the counter module 68 is shown in conjunction with the threshold detection module 72 and monitors the number of times the switch 16 moves between the first state and the second state. The counter module 68 may include a counter having a totalizer 120 in communication with an increment input 122, an output 124, and a reset input 126.

In operation, a transfer signal 121 is communicated to the increment input 122 and may include information indicating that at least one of the switches 50-57 has moved or is in the process of moving between the first and second states and/or information identifying the particular switch 50-57. The increment input 122 may instruct the totalizer 120 to increment the number of operations of the particular switch or switches 50-57 under review. The totalizer 120 may sum the increment with the previous number of switching operations and may communicate the total number of switching operations to the output 124. The output 124 may communicate the counter information—including the total number of switching operations—to the threshold detection module 72 and/or to module 70. The reset input 126 may cause the totalizer 120 to reset the total number of switching operations upon communication of the maintenance alert reset 90.

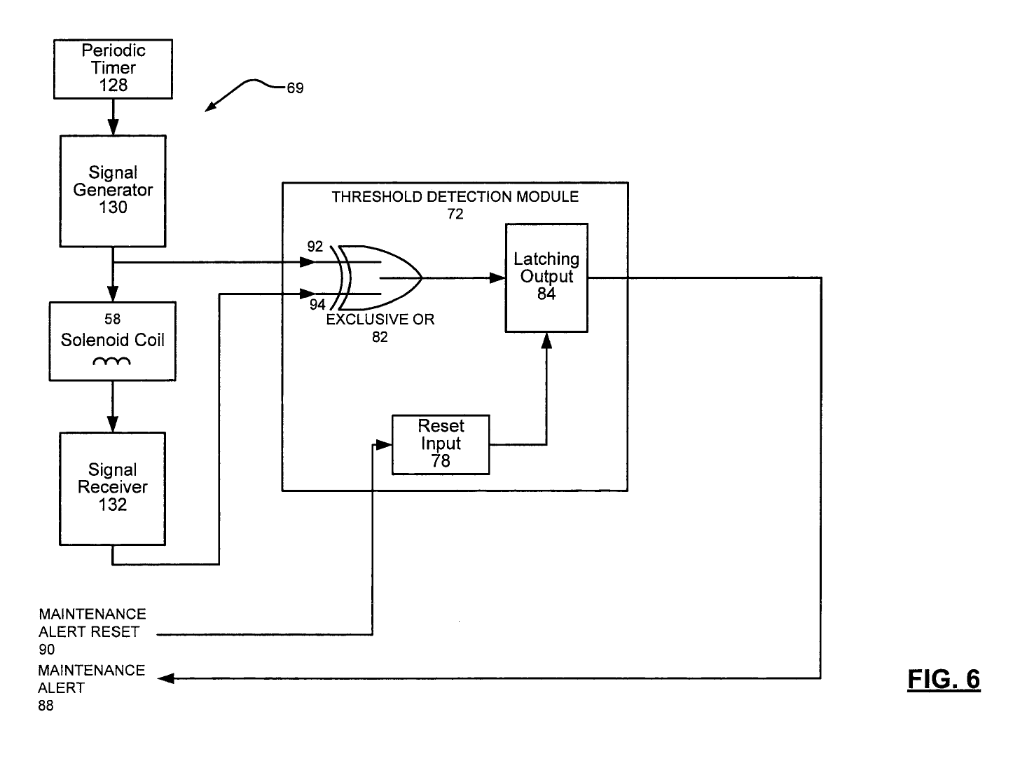

With particular reference to FIG. 6, the coil continuity test module 69 is shown in conjunction with the threshold detection module 72 and monitors the continuity of the transfer switch 10. The coil continuity test module 69 may include a periodic timer 128, a signal generator 130, and/or a signal receiver 132.

In operation, the periodic timer 128 may instruct the signal generator 130 to generate and direct a signal to the switch 16 including the solenoid coil 58. The signal generated by the generator 130 may also be sent to the threshold detection module 72 and may be received at the first input 92 of the threshold detection module 72. The generated signal may be received by the signal receiver 132, which may communicate the received signal to the second input 94 of the threshold detection module 72. The comparison of the generated signal and the received signal may include continuity information regarding the solenoid 58. The generated signal may be an analog signal, a digital signal, and/or a low-level electrical current sufficient to pass through but not energize the coil 58.

As described above and as shown in FIGS. 3-6, the temperature module 64, the timer module 66, and the counter module 68 may be in communication with the data logging and peak detection module 70 to provide information to the data logging and peak detection module 70 that is indicative of the performance of the transfer switch 10. Likewise, the temperature module 64, the timer module 66, the counter module 68, the coil continuity test module 69, and the data logging and peak detection module 70, may be in communication with the threshold detection module 72 to provide information to the threshold detection module 72 that is indicative of the performance of the transfer switch 10.

The data logging and peak detection module 70 may include a peak detector 96 and storage 98, which may include a computer readable memory. The storage 98 may store information related to the reference thresholds 87 and/or the monitored operating conditions of the transfer switch 10 for later recall and/or analysis. In practice, maintenance or operations personnel may be able to access the storage 98 and/or peak detector 96 to perform diagnostics on the transfer switch 10 through a user interface located on the transfer switch housing 12 or remotely over a LAN, WAN, and/or a wireless connection.

The peak detector 96 may detect a peak operating condition for later recall and/or analysis. The peak detector 96 may include circuitry and/or computer readable storage to compare information of a current operating condition of the transfer switch 10—such as a temperature of at least one of the contacts 26-48 or the time required to actuate at least one of the switches 50-57—and past operating conditions of the transfer switch 10.

In addition to comparing current and past operating conditions at the peak detector 96, the module 70 may also store the peak value for a particular operating condition or conditions. The peak value or values may be stored in the storage 98 or may be stored in separate, dedicated storage (not shown). The peak detector 96 may be integrated into the circuitry of the controller 14 such that the controller 14 performs the functions of the peak detector 96. Alternatively, the peak detector 96 may be separate from the controller 14 and may be in communication with the controller 14.

The threshold detection module 72 may include various configurations and may include an input 74, a threshold input 76, a reset input 78, a comparator 80, a latching output 84, and/or an output 86 (FIG. 5). The threshold detection module 72 may include processing circuitry and/or memory (neither shown) and may receive information from any or all of modules 64, 66, 68, 69, 70 relating to an operating condition of the transfer switch 10 and/or reference thresholds 87. For example, the threshold detection module 72 may receive information such as, for example, timing information relating to how long it takes for the transfer switch 10 to move between the first state and the second state, the number of times the transfer switch 10 has been cycled between the first state and the second state, continuity information regarding the solenoid 58, and/or temperature information relating to a temperature of the transfer switch 10 during or immediately following operation thereof. Such information may be communicated to the threshold detection module 72 at input 74.

A reference threshold 87 may be communicated to the threshold detection module 72 at the threshold input 76 and may provide the threshold detection module 72 with a reference value or a series of reference values for comparison to the input(s) received from 13, 64, 66, 68, 68, and 70 at input 74. The reference thresholds 87 may be stored in the memory 13 and/or the data logging and peak detection module 70 for use by the threshold detection module 72. Specifically, the comparator 80 may compare information received at input 74 from at least one of the temperature module 64, the timer module 66, the counter module 68, and the coil continuity test module 69 to the reference threshold 87 value(s) received at the threshold input 76 and may output a result of the comparison to the latching output 84 and/or output 86.

The result may be indicative of a maintenance condition when the information received from at least one of the modules 64, 66, 68, 69 equals or exceeds the reference threshold 87. For example, the temperature module 64 may provide information to the threshold detection module 72 indicating an operating temperature of the transfer switch 10. If the operating temperature exceeds a temperature threshold value received at threshold input 76, the threshold detection module 72 may determine a maintenance condition and alert a service technician to repair or replace the transfer switch 10.

The latching output 84 and/or output 86 may communicate such a maintenance condition by issuing a maintenance alert 88. If the threshold detection module 72 includes a latching output 84 (FIGS. 3, 4, and 6), once the latching output 84 receives a comparison result indicative of a maintenance condition from the comparator 80, the maintenance alert 88 may be continually transmitted irrespective of later comparison results generated by the comparator 80. The maintenance alert 88 may be transmitted until a maintenance alert reset 90 is received by the reset input 78, thereby causing the latching output 84 to reset to ensure the maintenance alert 88 was received.

The reference threshold 87 may include a predetermined threshold value or values indicative of a maintenance condition or conditions of the transfer switch 10. Specifically, the threshold values may provide a reference for comparing information received from at least one of the modules 64, 66, 68, 69 to determine whether any operating conditions of the transfer switch 10 equal or exceed the threshold values to determine whether maintenance is needed.

In one configuration, the reference threshold 87 may be stored in the memory 13 and/or the data logging and peak detection module 70 of the controller 14 and may be received by the controller 14 via a user input. The threshold values may include, but are not limited to, information regarding the total number of switching operations performed by the transfer switch 10, the time required for the switch 16 to move between the first state and the second state, the continuity of the solenoid 58, and/or a temperature of the transfer switch 10.

The maintenance alert 88 may communicate that the monitored operating condition of the transfer switch 10 is indicative of a maintenance condition. In operation, an operations or maintenance person may receive the maintenance alert 88 and may perform maintenance on the transfer switch 10. In some arrangements, the maintenance alert may continue to be communicated until maintenance to the transfer switch 10 is performed. Additionally, the controller 14 may continue to monitor the transfer switch 10 after a maintenance alert is communicated and may continue to communicate additional maintenance alerts based on continued monitoring of the transfer switch 10.

The maintenance alert 88 may include information about the type and/or severity of the maintenance condition, the date and time of the maintenance condition, pertinent diagnostic information, operability of the transfer switch 10, and/or any other information that the controller 14 collects or monitors. Moreover, the maintenance alert 88 may be a transfer timer maintenance alert, an operations counter maintenance alert, an electrical wear maintenance alert, and/or a continuity maintenance alert. The maintenance alert 88 may be communicated in various ways such as, for example, wired or wireless transmission, visual, audio, email, and/or text message.

As shown in FIG. 6, threshold detection module 72 may include an exclusive-or gate 82, a latching output 84, and/or a reset input 78. The gate 82 may receive a first signal at a first input 92 and a may receive a second signal at a second input 94. The gate 82 may output a result to the latching output 84 when one of the inputs 92, 94 to the gate 82 is true. If one of the inputs 92, 94 is true, the latching output 84 may then communicate the maintenance alert 88. If, however, both inputs 92, 94 are false or both inputs 92, 94 are true, the gate 82 does not provide an output and the latching output 84 does not generate the maintenance alert 88.

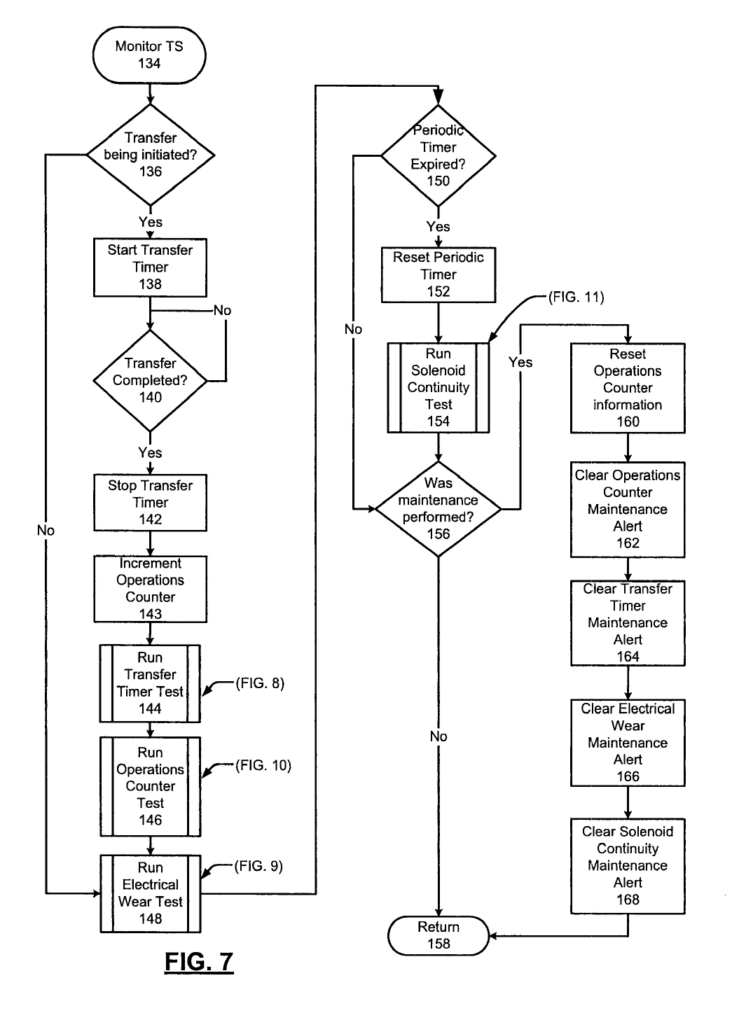

With reference to FIG. 7, operation of the controller 14 will be described in detail. The controller 14 may monitor the transfer switch 10 for the occurrence of an operating condition at 134. The controller 14 may determine whether the transfer switch 10 is transferring power between states at 136. If the controller 14 determines that a transfer is occurring, the controller 14 may start the timer module 66 at 138, virtually simultaneously with initiation of movement of the switch 16 and begin timing the movement. At 140, the controller 14 may determine whether the switch 16 is still moving between states. If the switch 16 is still moving between states, the controller 14 may continue to time the transfer. After a maximum amount of time or with the completion of the switch 16 movement, the timer module 66 may be stopped at 142. The controller 14 may increment the counter module 68 at 143, may perform the transfer timer test at 144, and may perform the operations counter test at 146.

If the controller 14 determines that a transfer is not being initiated at 136, the controller 14 may perform the electrical wear test at 148. Further, the controller 14 may determine whether the periodic timer 128 has expired at 150. If the periodic timer 128 has expired, the controller 14 may reset the periodic timer 128 at 152 and may perform the solenoid continuity test at 154. If the periodic timer 128 has not expired, the controller 14 may determine whether maintenance was performed on the transfer switch 10 at 156. Maintenance may be required if one of the tests indicates a maintenance condition. The transfer timer test 144, the operations counter test 146, the electrical wear test 148, and/or the solenoid continuity test 150 may indicate that an operating condition the transfer switch 10 is indicative of a maintenance condition and generate a maintenance alert 88.

The maintenance alert 88 may indicate the nature of the maintenance condition and may identify necessary maintenance for performance on the transfer switch 10. If the controller 14 determines that maintenance was not performed, the controller 14 returns to monitoring the transfer switch 10 at 158. If maintenance is performed, the controller 14 and/or the maintenance person may reset the operations counter information at 160, clear the operations counter maintenance alert at 162, clear the transfer timer maintenance alert at 164, clear the electrical wear maintenance alert at 166, and/or clear the solenoid continuity maintenance alert at 168. The foregoing may be accomplished by a maintenance alert reset signal 90. The controller 14 may then return to monitoring the transfer switch 10 at 158.

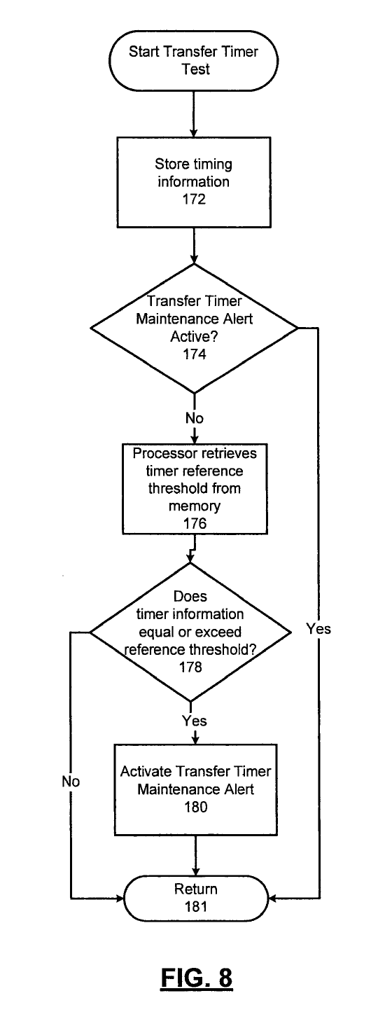

With reference to FIG. 8, operation of the timer module 66 will be described in detail. The timer module 66 may perform the transfer timer test identified in FIG. 7 at 144 to determine whether the switch 16 moves between the first state and the second state within a prescribed time period.

Initially, timing information related to switch operation may be stored in module 70 and/or in the memory 13 at 172. The controller 14 may then determine whether the transfer timer maintenance alert is active at 174. If the transfer timer maintenance alert is active, the controller 14 returns to monitoring the operating conditions of the transfer switch 10. If the transfer timer maintenance alert it not active, the threshold detection module 72 may retrieve the timer reference threshold from the memory 13 or module 70 at 176.

The threshold detection module 72 may compare the timer information with the timer reference threshold at 178. If the timer information equals or exceeds the timer reference threshold, the controller 14 may activate the transfer timer maintenance alert at 180 and may return to monitoring the transfer switch 10 at 181. If the timer information 15 does not equal or exceed the timer reference threshold, the controller 14 will return to monitoring the transfer switch 10 at 181.

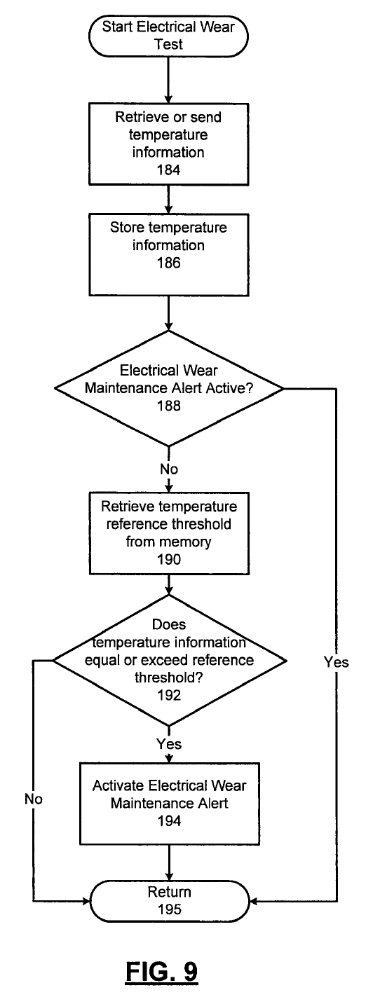

With reference to FIG. 9, operation of the temperature module 64 will be described in detail. The temperature module 64 may perform the electrical wear test identified in FIG. 7 at 148 to determine whether the temperature of the switch 16 is within a prescribed temperature range when actuated between the first state and the second state.

Initially, the controller 14 may receive temperature information at 184 from the temperature module 64 and/or the temperature sensors 116. The temperature information may be stored in memory 13 or module 70 at 186. The controller 14 may then determine whether the electrical wear maintenance alert is active at 188. If the electrical wear maintenance alert is active, the controller 14 returns to monitoring the operating conditions of the transfer switch 10 at 195. If the electrical wear maintenance alert is not active, the threshold detection module 72 may retrieve the temperature reference threshold from the memory 13 or module 70 at 190.

The threshold detection module 72 may compare the temperature information with the temperature reference threshold at 192. If the temperature information equals or exceeds the temperature reference threshold, the controller 14 may activate the electrical wear maintenance alert at 194 and may return to monitoring the transfer switch 10 at 195. If the temperature information does not equal or exceed the temperature reference threshold information, the controller 14 will return to monitoring the transfer switch 10 at 195.

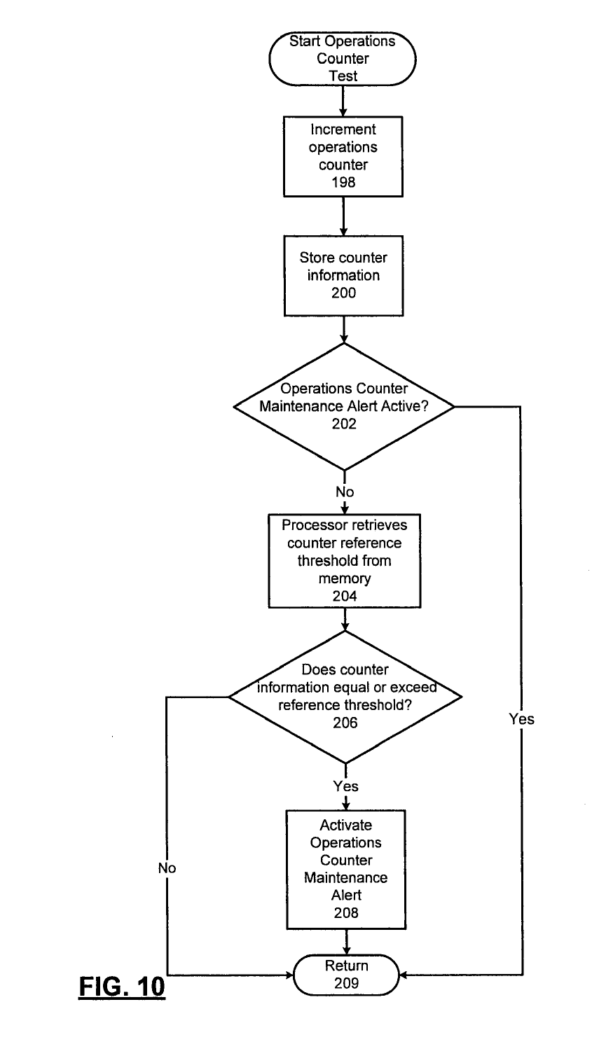

With reference to FIG. 10, operation of the counter module 68 will be described in detail. The counter module 68 may perform the run operations counter test identified in FIG. 7 at 146 to determine whether the switch 16 has been cycled between the first state and the second state more than a threshold number of times.

Initially, a change in states (i.e., between the first state and the second state) of the transfer switch 10 may cause the counter module 68 to increment and output counter information at 198. The controller 14 may store the counter information to module 70 and/or the memory 13 at 200. The controller 14 may then determine whether the operations counter maintenance alert is active at 202. If the operations counter maintenance alert is active, the controller 14 returns to monitoring the operating conditions of the transfer switch 10 at 209. If the operation counter maintenance alert is not active, the threshold detection module 72 may retrieve the counter reference threshold from the memory 13 or module 70 at 204.

The threshold detection module 72 may compare the counter information with the counter reference threshold at 206. If the counter information equals or exceeds the counter reference threshold, the controller 14 may activate an operations counter maintenance alert at 208 and may return to monitoring the transfer switch 10 at 209. If the counter information 15 does not equal or exceed the counter threshold information at 206, the controller 14 will return to monitoring the transfer switch 10 at 209.

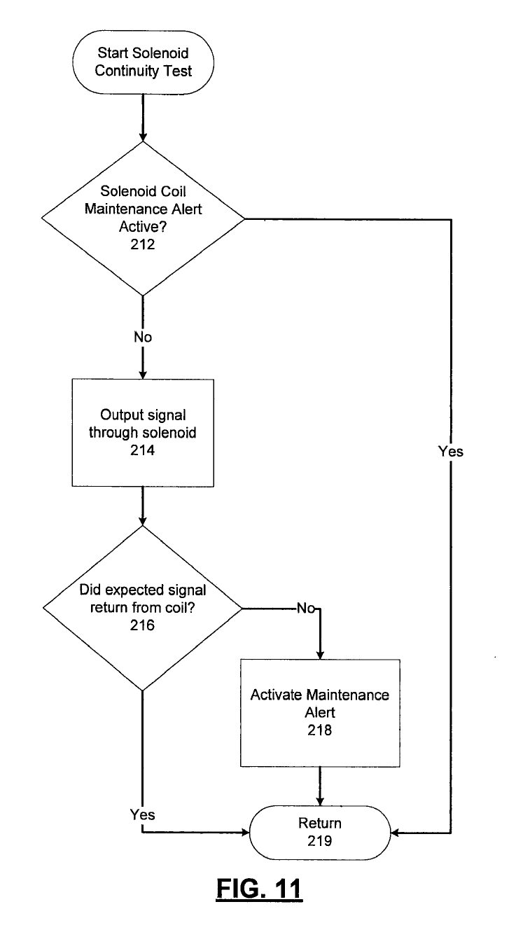

With reference to FIG. 11, operation of the coil continuity test module 69 will be described in detail. The coil continuity test module 69 may perform the solenoid continuity test identified in FIG. 7 at 154 to determine whether the solenoid 58 has continuity.

Initially, the controller 14 may determine whether the solenoid continuity maintenance alert is active at 212. If the solenoid continuity maintenance alert is active, the controller 14 returns to monitoring the operating conditions of the transfer switch 10 at 219. If the solenoid continuity maintenance alert is not active, the signal generator 130 may output a signal through the solenoid 58 at 214. The threshold detection module 72 may compare the generated signal with the received signal at 216 and may determine whether the expected signal returned from the coil 58. If the expected signal did not return from the coil 58, the controller 14 may activate a solenoid continuity maintenance alert at 218 and may return to monitoring the transfer switch 10 at 219. If the expected signal returned from the coil 58, the controller 14 will return to monitoring the transfer switch 10 at 219.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A method comprising
monitoring a transfer switch;
determining an operating condition of said transfer switch based on said monitoring;
comparing by a processor said operating condition to a predetermined value; and
determining a maintenance condition of said transfer switch based on said comparison.

2. The method of claim 1, further comprising generating a maintenance alert based on said maintenance condition.

3. The method of claim 1, wherein monitoring said transfer switch includes monitoring the number of times said transfer switch moves between a first state and a second state.

4. The method of claim 1, wherein determining said operating condition includes determining a number of times said transfer switch moves between a first state and a second state.

5. The method of claim 1, wherein monitoring said transfer switch includes monitoring a temperature of said transfer switch.

6. The method of claim 1, wherein determining said operating condition includes determining a temperature of said transfer switch.

7. The method of claim 1, wherein monitoring said transfer switch includes monitoring the continuity of said transfer switch.

8. The method of claim 1, wherein determining said operating condition includes determining a continuity of said transfer switch.

9. The method of claim 1, wherein monitoring said transfer switch includes monitoring the time required for said transfer switch to move from a first state to a second state.

10. The method of claim 1, wherein determining said operating condition includes determining the time required for said transfer switch to move from a first state to a second state.

11. A controller for monitoring operation of a transfer switch, the controller comprising:
a processor receiving at least one operating condition of the transfer switch and comparing said at least one operating condition to at least one predetermined value, said processor determining a maintenance condition of the transfer switch based on said comparison.

12. The controller of claim 11, wherein said controller generates a maintenance alert based on said maintenance condition.

13. The controller of claim 11, wherein said at least one operating condition includes the number of times the transfer switch moves between a first state and a second state.

14. The controller of claim 11, wherein said at least one operating condition includes a temperature of the transfer switch.

15. The controller of claim 11, wherein said at least one operating condition includes monitoring the continuity of the transfer switch.

16. The controller of claim 11, wherein said at least one operating condition includes the time required for the transfer switch to move from a first state to a second state.

17. The controller of claim 11, wherein said at least one operating condition includes the number of times the transfer switch moves between a first state and a second state, a temperature of the transfer switch, monitoring the continuity of the transfer switch, and the time required for the transfer switch to move from a first state to a second state.
